(19) United States
(12) Patent Application Publication
(10) Pub. No.: US 2015/0276269 A1
(43) Pub. Date: Oct. 1, 2015

(54) REMOTELY CONTROLLED PORTABLE HEATER

(71) Applicant: RESTLESS NOGGINS DESIGN, LLC, North Canton, OH (US)

(72) Inventor: Hope D. Paolini, Canton, OH (US)

(73) Assignee: RESTLESS NOGGINS DESIGN, LLC, North Canton, OH (US)

(21) Appl. No.: 14/226,261

(22) Filed: Mar. 26, 2014

(51) Int. Cl. F24H 9/20; H04W 4/12; G05D 23/19; F24H 3/02

(52) U.S. Cl. CPC F24H 9/2071; F24H 3/022; H04W 4/12; G05D 23/1904; G05D 23/1905

(57) ABSTRACT

A system and method for controlling a portable space heater is presented. The portable space heater includes a housing, a heating unit and a control processor. The heating unit is contained in the housing. The control processor receives a wireless message from a wireless network and then decodes the wireless message and controls the portable space heater based on the wireless message.

### BACKGROUND OF THE INVENTION

1. Field of Invention

The current invention relates generally to apparatus, systems and methods for heating areas. More particularly, the apparatus, systems and methods relate to a portable space heater that is remotely controlled over a network. Specifically, the apparatus, systems and methods provide for a portable space heater, purifier and fan.

2. Description of Related Art

Whole house central heaters are a common way of providing heat within the home. Central heaters are generally controlled with one central controller based on the temperature at that location. If the temperature falls below a preset value at that location the central heater turns on and the entire house or building is heated. This can be wasteful in terms of energy consumed if only one or a few rooms in the home/building are occupied.

In an effort to remedy the need of heating an entire home/building to the same temperature, portable electric heaters have been developed. The portable heaters can come with attractive appearances such as looking like a traditional fireplace, have shelving and provide storage along with the additional benefit of being portable. Since space heaters are portable, space heaters can be moved from room to room or repositioned within a room with very little effort. However, space heaters can become blocked by furniture, stacks of newspapers or books and covered with cloths or other objects. This stops airflow through space heaters causing them to heat up and become fire hazards. What is needed is a better space heater.

### SUMMARY

The preferred embodiment of the invention includes controlling a portable space heater with messages sent from a remote device over a wireless network. The portable space heater includes a housing, a heating unit and a control processor. The heating unit is contained in the housing. The control processor receives a wireless message from a wireless network and then decodes the wireless message and controls the portable space heater based on the wireless message.

Another configuration of the preferred embodiment is a method of operating a portable space heater. A wireless message is received from a wireless network. The portable space heater is then controlled based on instructions in the wireless message

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example illustration of a preferred embodiment of a portable space heater that can be controlled from a remote location over a network.

FIG. 2 illustrates an example back view of the preferred embodiment of a portable space heater.

FIG. 3 illustrates an example control panel used to control the preferred embodiment of the portable space heater.

FIG. 4 illustrates an example remote device and network used to control the preferred embodiment of the portable space heater.

FIG. 5A illustrates an example software menu page used to control the preferred embodiment of the portable space heater from a remote location.

FIG. 5B illustrates another example software menu page used to control the preferred embodiment of the portable space heater from a remote location.

FIG. 6A illustrates a method diagram for changing the temperature of the preferred embodiment of the portable space heater.

FIG. 6B illustrates one state of an example interface for changing the temperature of the preferred embodiment of the portable space heater.

FIG. 7A illustrates a method diagram for setting a mode of the preferred embodiment of the portable space heater.

FIG. 7B illustrates one state of an example interface for setting a mode of the preferred embodiment of the portable space heater.

FIG. 8A illustrates the method diagram for setting a schedule of the preferred embodiment of a portable space heater.

FIG. 8B illustrates one state of an example interface for setting a schedule of the preferred embodiment of the portable space heater.

FIG. 9 illustrates a method diagram for setting a timer program of the preferred embodiment of the portable space heater when the space heater is off.

FIG. 10 illustrates a method diagram for setting timer program of the preferred embodiment of the portable space heater when the space heater is on.

Similar numbers refer to similar parts throughout the drawings.

### DETAILED DESCRIPTION

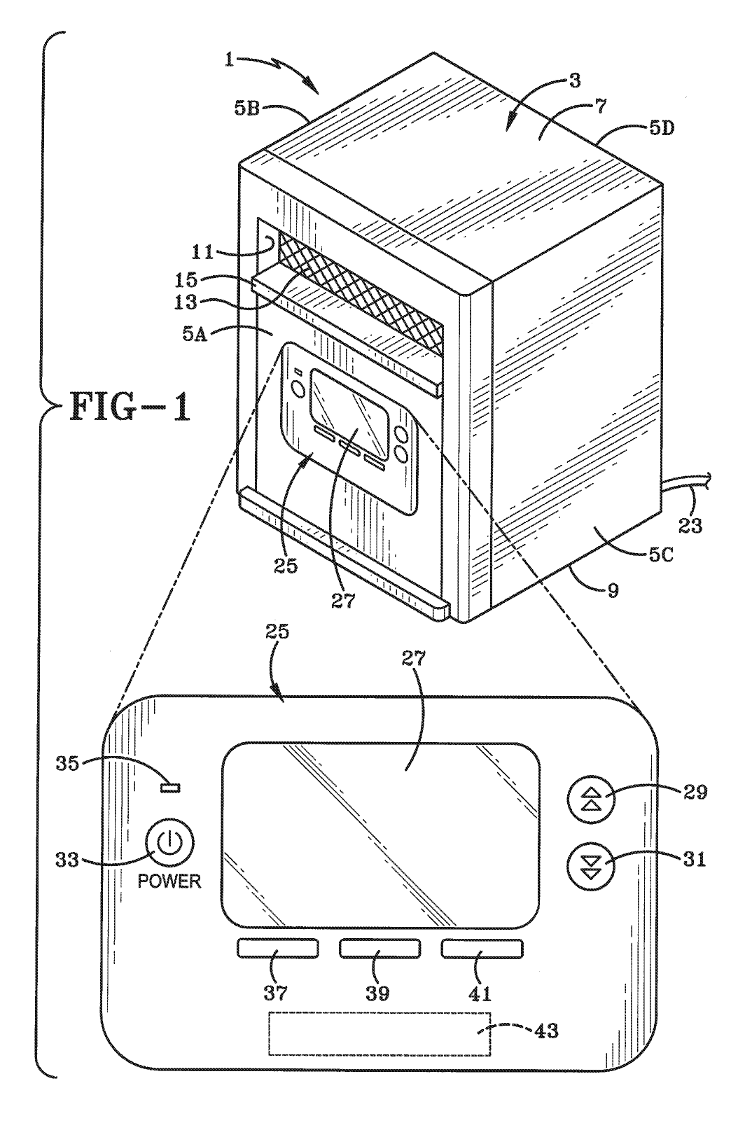

FIG. 1 illustrates the preferred embodiment of a portable unit 1 (portable space heater). The portable unit 1 can operate as a space heater, an air purifier, and a fan. One novel aspect of the portable unit 1 is that it can be programmed from a remote electronic device communicating with it over a wireless network and can be programmed for different operations at different times throughout an entire week. The unit 1 includes a housing 3 with a front wall 5A, left wall 5B, right wall 5C and a back wall 5D. The housing has a top 7 and a bottom 9. An opening 11 is formed in the front wall 5A with a protective grill 13 installed in the opening 11. In the preferred embodiment, a decorative ledger 15 formed out of plastic and colored to appear as a piece of wood is formed on the bottom of the opening 11. As illustrated in FIG. 2, the back wall 5D includes an opening 17 with a protective grill 19. In the preferred embodiment, the protective grill 19 snaps on and off of the back wall 5D holding a plastic air filter 21 between it and the back wall 5D to filter air going into the opening 17. This allows the filter 21 to easily be washed with water on a periodic basis, preferably after each daily use. A power cord 23 exits the back wall 5D and can preferably be power cord 23 that attaches to a 110 volt electrical power supply.

The front wall 5A further includes a control panel 25 that includes a display 27 and a variety of buttons to control the unit 1. This control panel 25 and its display 27 and buttons are described with respect to the unit 1, however, this same or a similar control panel 25, display 27 and buttons could be implemented in a computer, I-pad, cellular phone or another electronic device to remotely control the space heater/purifier/fan 1 over a network similar to how it is controlled with buttons directly on the portable space heater 1. In the preferred embodiment, the display 27 is a light emitting diode (LED) display which works better than liquid crystal/glass displays on high temperature space heaters.

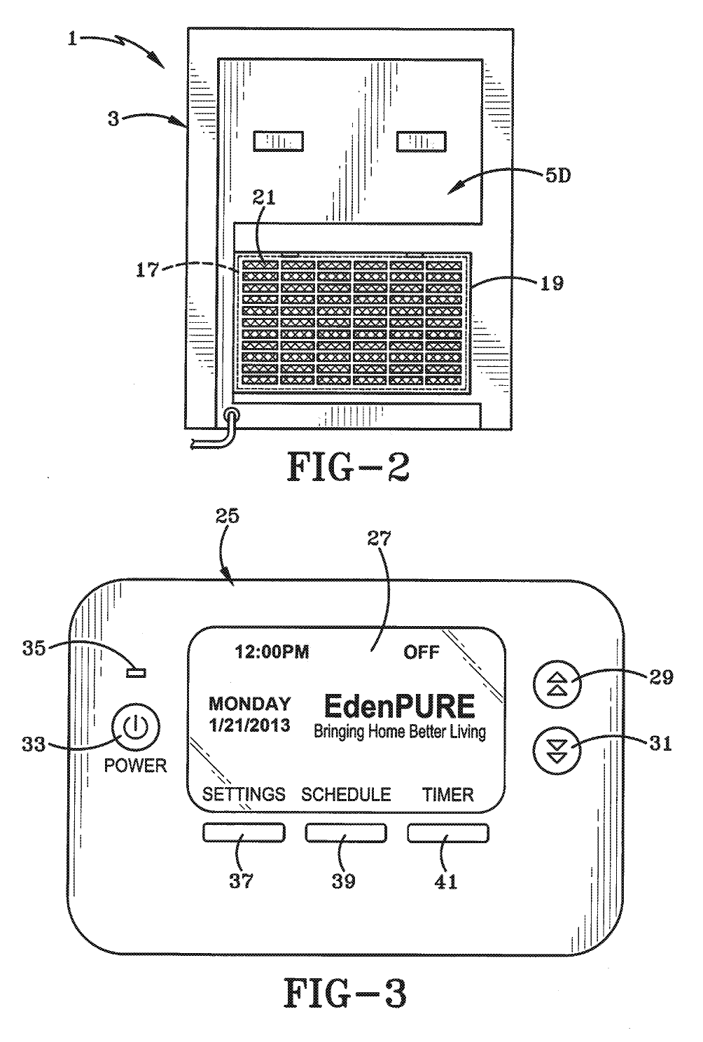

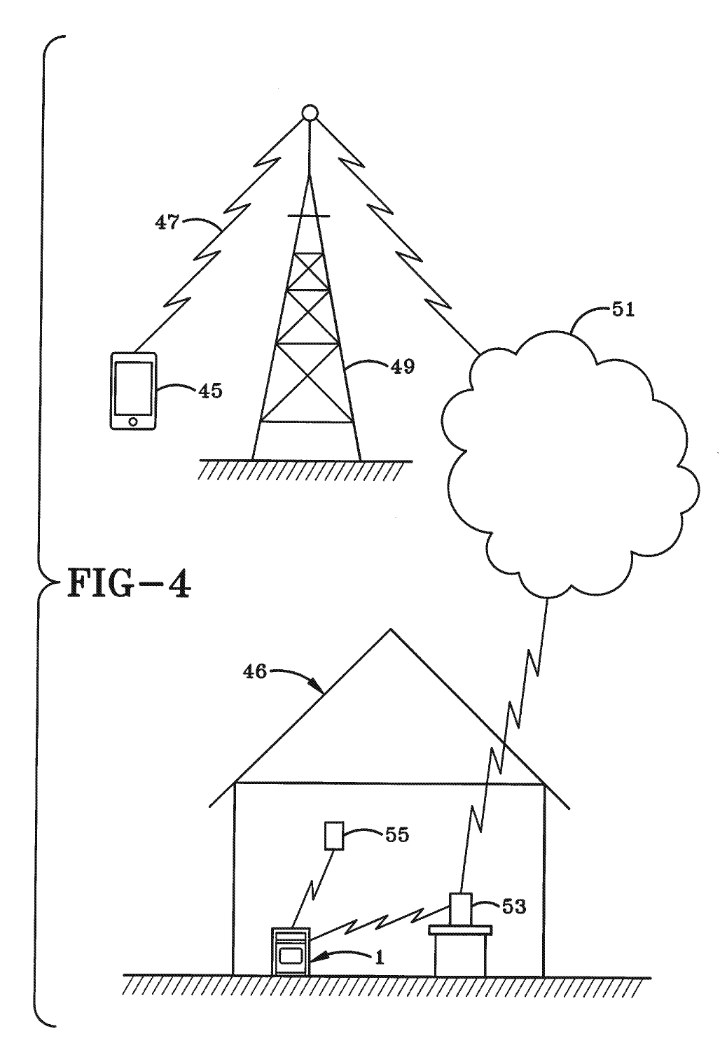

The control panel 25 (best seen in FIG. 3) includes an up 29 button and a down 31 button. These buttons 29, 31 can be used to select a temperature or a day and time as described below. The control panel 25 further includes a power on button 33 used to power up the space heater/purifier 1 and a power on LED 35 that is illuminated to indicate that the space heater/purifier 1 is powered up. In the preferred embodiment, the control panel 25 has three other general purpose buttons: the back/mode/settings button 37, the select/hold/schedule button 39 and the done/timer button 41. These buttons take various functions as described below based on what mode the control panel 25 is in as described below.

The various actions executed by the control panel 25 are performed by a control processor 43 (FIG. 1) implemented, in the preferred embodiment, by logic implemented on a printed circuit board (PCB). “Logic”, as used herein, includes but is not limited to hardware, firmware, software and/or combinations of each to perform a function(s) or an action(s), and/or to cause a function or action from another logic, method, and/or system. For example, based on a desired application or needs, logic may include a processor such as a software controlled microprocessor, discrete logic, an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

As illustrated in FIG. 4, the preferred embodiment of the space heater can be controlled from one or more different locations. This means the control processor 43 can be implemented in more than one location or parts of the control processor 43 can be implemented in more than one location. For example a remote handheld device such as a wireless phone 45, iPad, laptop and the like can be used to control the unit 1 located in a home 46. Alternatively, a local remote control 55 such as an infra-red remote control or another local remote control can be used to directly control the unit 1. The phone 45 can establish a wireless link 47 with a cellular antenna 49 or another communications system. By using a medium access controller (MAC) address, internet protocol address, and/or another address associated with the unit 1, messages from the remote device 45 can be routed through a network 51 toward an example home/local WiFi 53. The home/local WiFi 53 can be an IEEE 802.11 wireless type of network. Those of ordinary skill in the art will understand that the home/local WiFi 53, the network 51 and the communication link(s) 47 could be other types of wireless and/or wired networks and can implemented in one or more protocols such as transmission control protocol/internet protocol (TCP/IP) and/or other protocols.

When the unit is initially plugged in or turned on, the control processor 43 can cause the display 27 to display “EdenPURE” or another message or indicator of what type of space heater it is. If this is the first time the unit 1 has been turned on, the control processor 43 can prompt through the display 27 a user to set the current time. Soft select button 39 can be used to move from hour to minutes to AM/PM while the up and down buttons 29, 31 can be used to selected minutes, hours and AM/PM. The done button 41 can be used to save the selected time. The setup process can be continued to selected a date using the soft select button 39 to move from month to day to year while using the up/down buttons 29, 31 to make the appropriate selections before using the done button 41 to lock in the selected date.

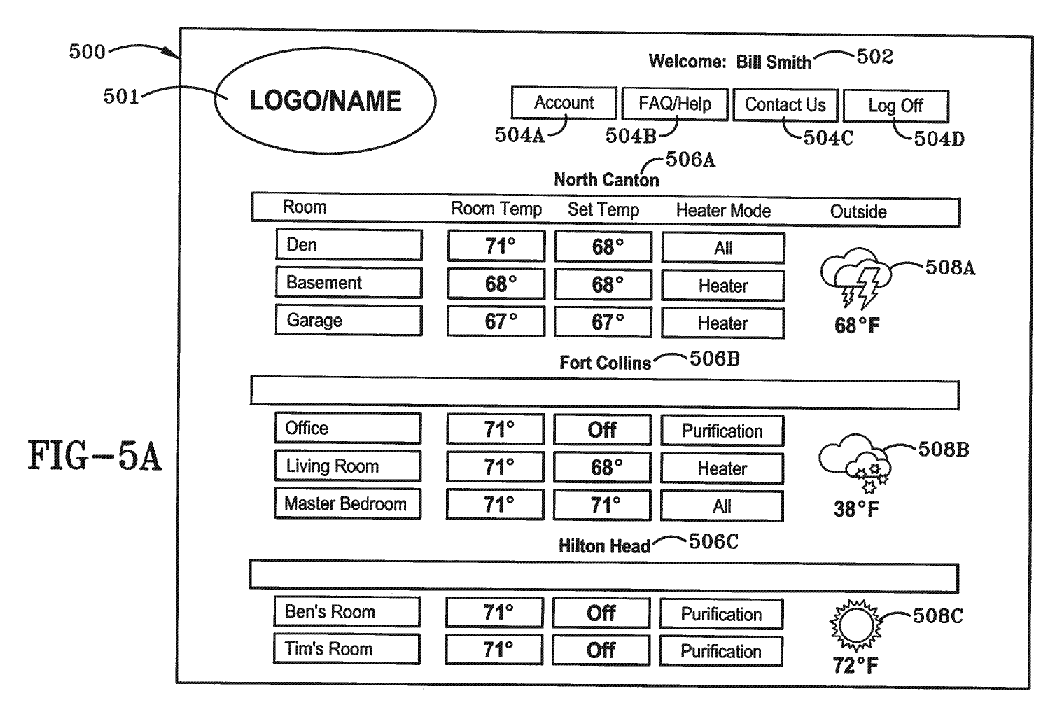

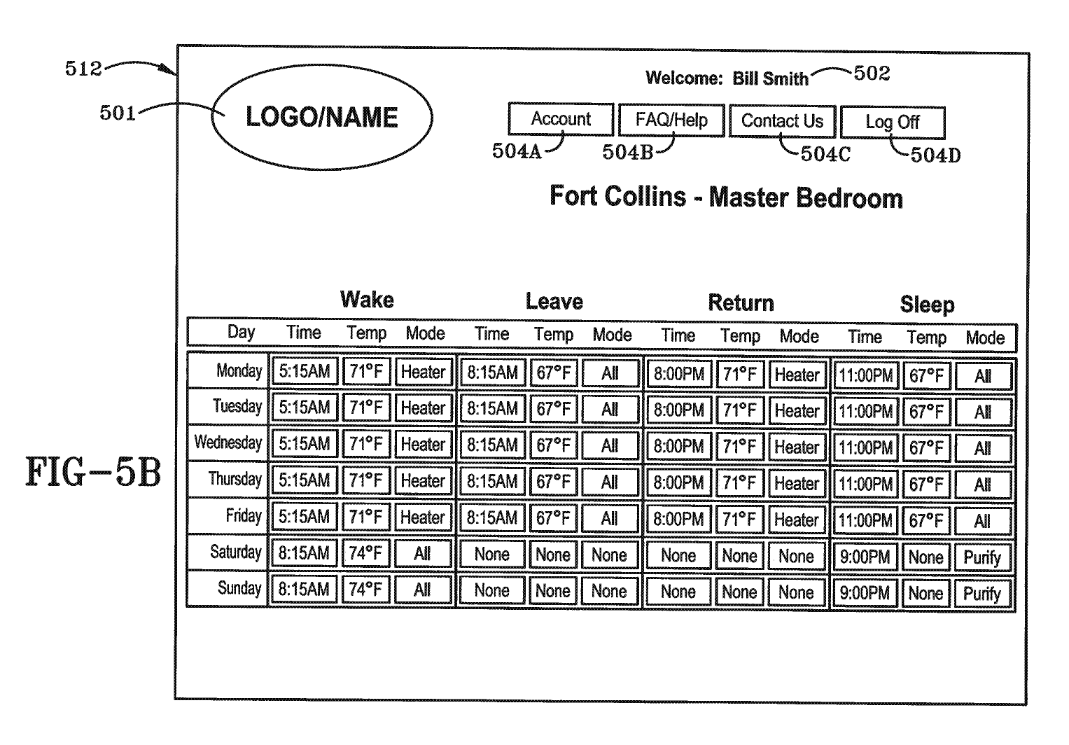

As mentioned before, the unit 1 can be controlled through its own control panel 25 or it can be controlled by a remote device at a remote location. In the preferred embodiment, any device with the ability to receive information with buttons or receive command in another way, as understood by those of ordinary skill in this art, can be used to program and control the heating unit 1. FIGS. 5A-B illustrate example displays that can assist in the programming of the unit. After creating an account and logging into that account, one may see the display 500 of FIG. 5A illustrates information about different units at three different locations 506A-C. The display 500 can include a welcome greeting and a user name 502 as well a logo/name 501 of the manufacture of the heating unit 1. Various tabs 504A-D can be displayed and used to navigate to other pages. In this example, the status of seven different heating units 1 at three different locations are displayed along with weather data corresponding with each of these locations. A weather indicator symbol 508A-C can also be displayed. FIG. 5B illustrates in more detail a display 512 of the weekly settings of a unit located at Fort Collins in the master bedroom. For each day of the week, wakeup time and temperatures can be set along with an operating mode of the unit. In the preferred embodiment, operating modes include “fan only”, “purify only”, “heat only” and “heat and purify” or a combination of these modes. Time, temperature and operating modes can also be specified for leave/return times and for sleep time. Other embodiments can have other times.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

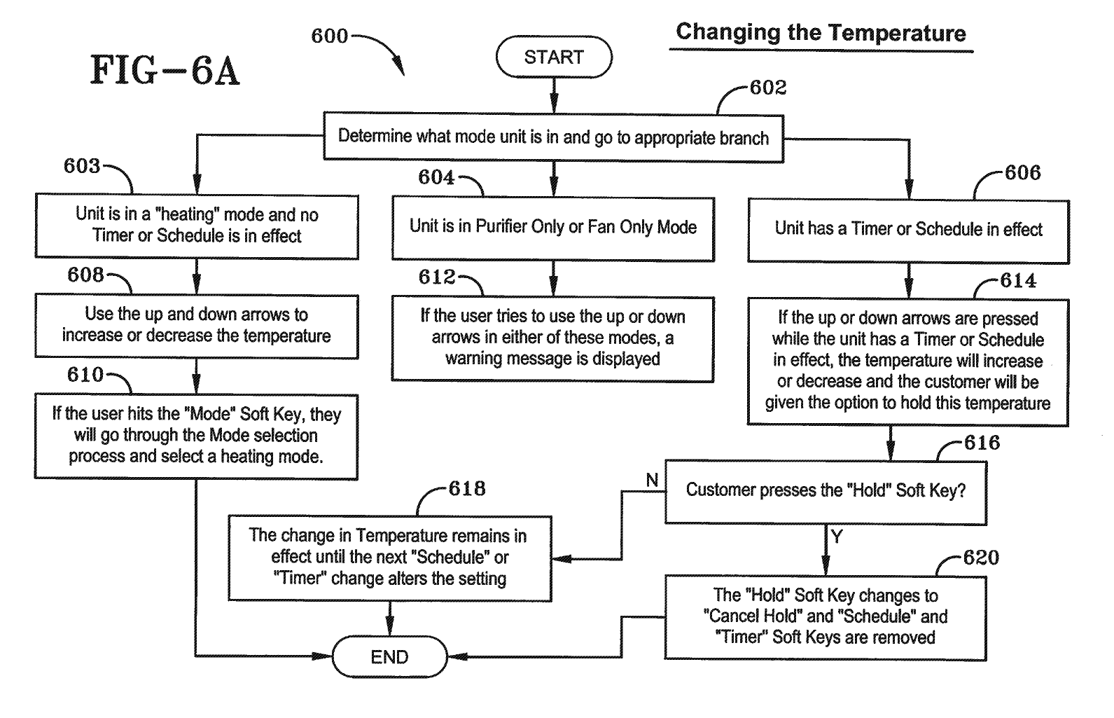

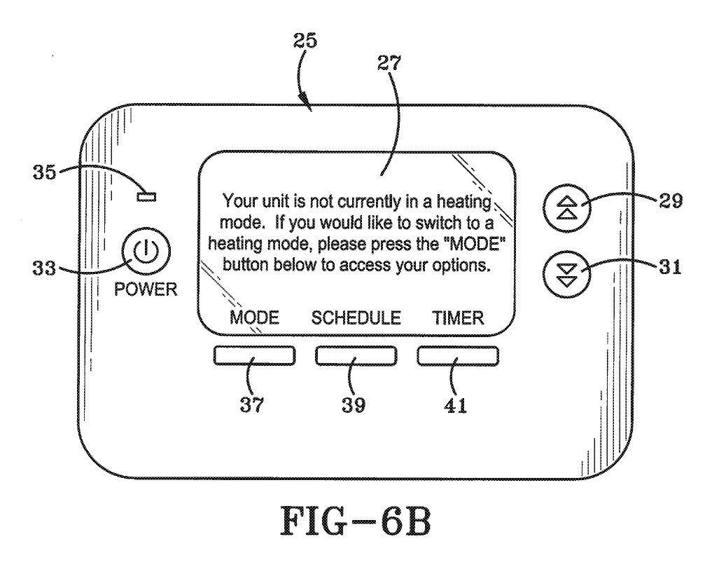

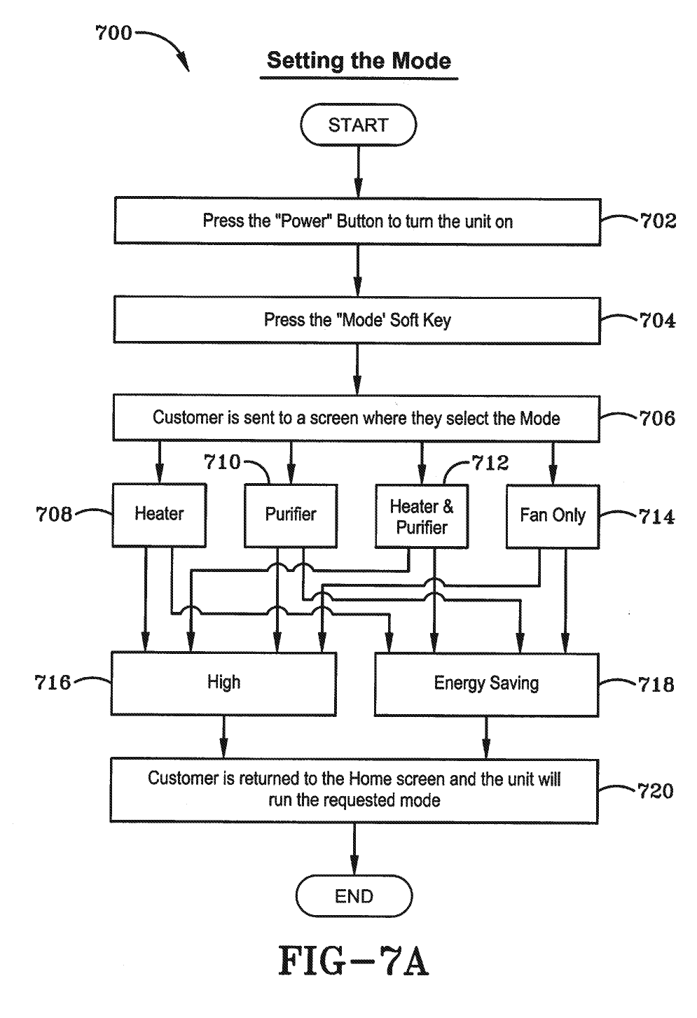

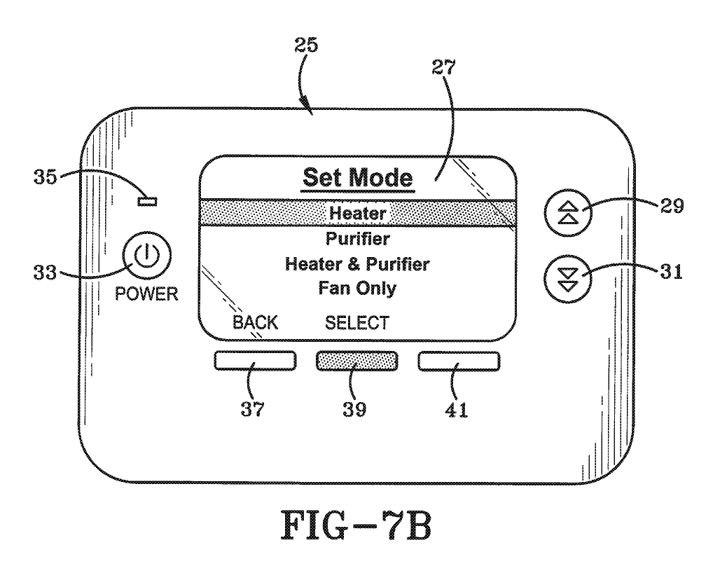

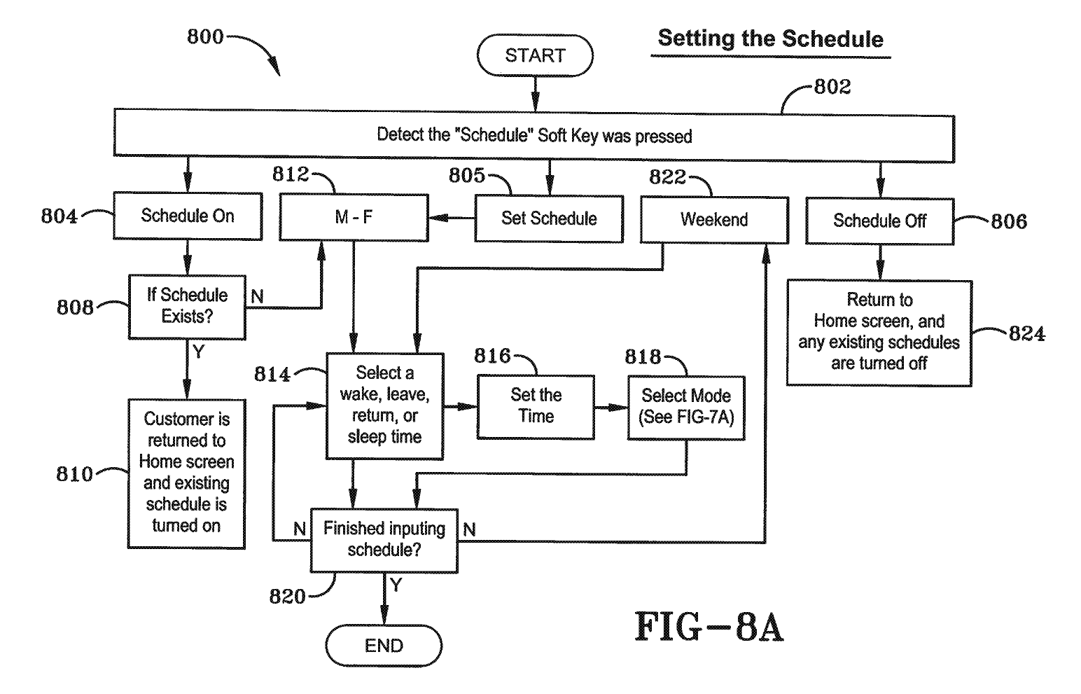

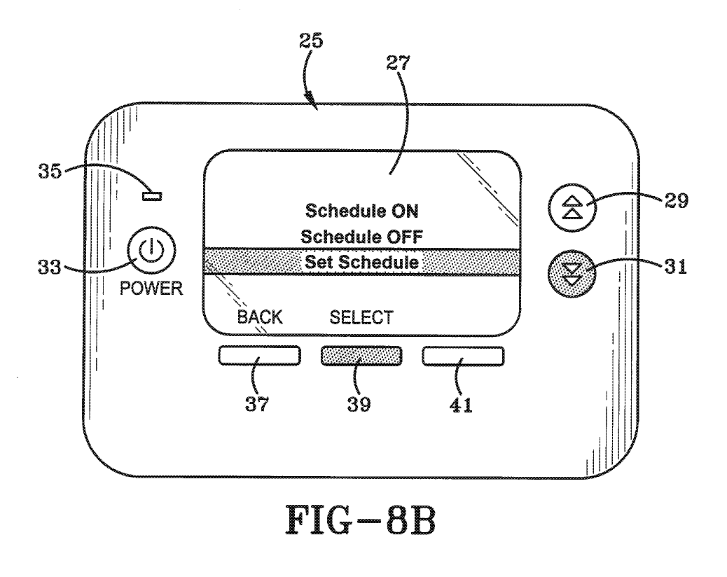

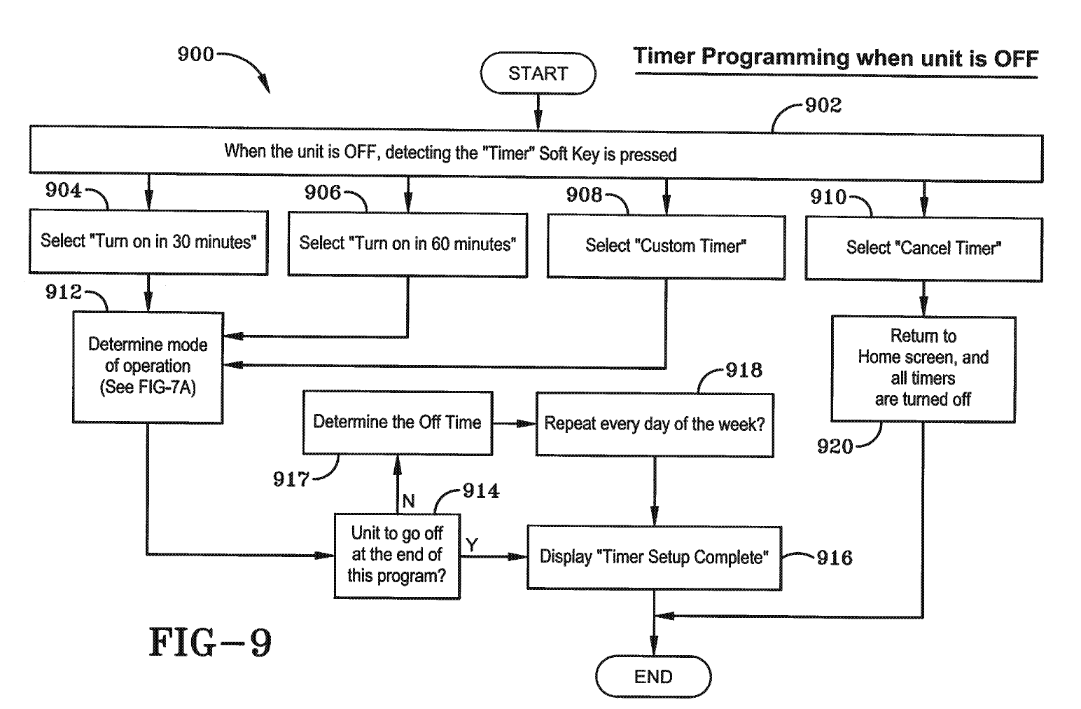

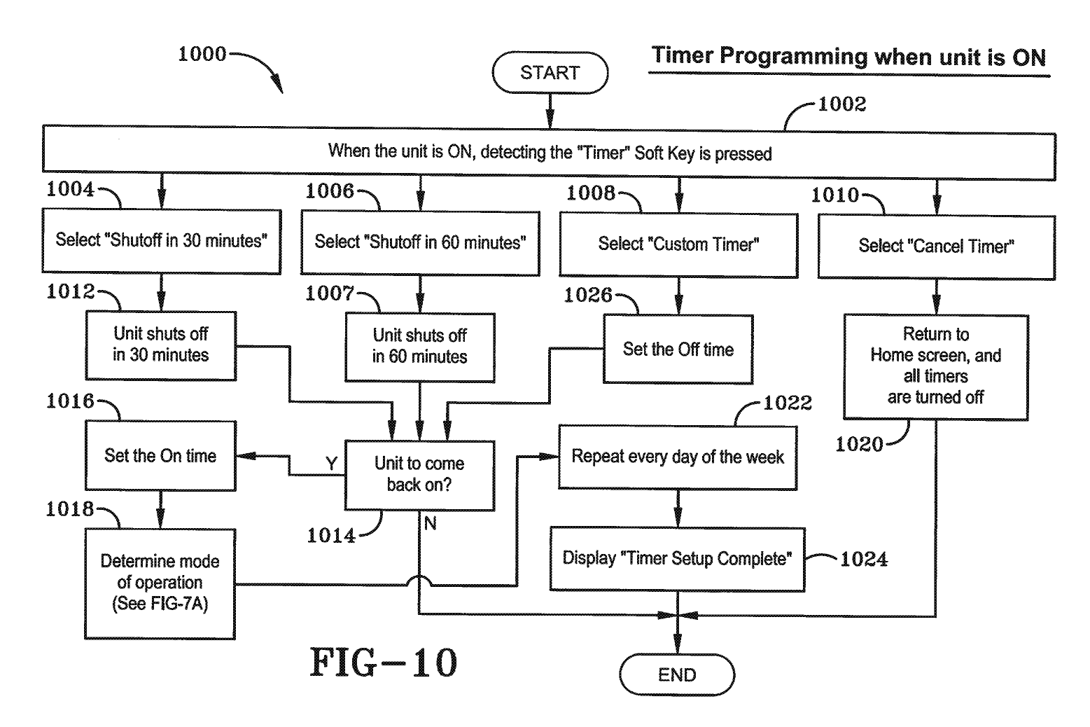

FIG. 6A illustrates an example method 600 of how to change the temperature of the preferred embodiment of the unit 1. The method 600 begins by determine what mode the space heater is in, at 602. Based on that determination flow continues to either the unit 1 is in (1) “heating” mode and no setting the timer or schedule changes are being performed (block 603), (2) “purifier only” mode or “fan only” mode (block 604) or (3) “timer” or “schedule” change mode (block 606). If in “heating” mode, the up and down arrows 29, 31 are used to select a temperature, at 608. If the mode soft key 37 is pressed, the user is presented a mode selection process, at 610. The mode selection process is described in detail with reference to FIG. 7.

If the unit 1 is in “purifier only” or “fan only” mode and a user tries to use the up and down arrow buttons 29, 31 then the following message is presented on the display 27, at 612: “Your unit is not currently in a heating mode. If you would like to switch to a heating mode, please press the “MODE” button below to access your options.” This example message is illustrated in FIG. 6B. If the up and down arrows 29, 31 are pressed while in “timer” and “schedule” change mode, the temperature will change, at 614, and the user will be give an option to save the new temperature. If the user does not press the soft “hold” key 39, at 616, then the change remains in effect until the next “timer” or “schedule” change, at 618, alters the setting. If the soft “hold” key 39 is pressed, at 616, then the “hold” key 39 changes to “cancel hold”, at 620, and the “cancel hold”, “schedule” and “timer” soft keys as well as the “schedule on” and “timer on” messages disappear from the display 27.

FIG. 7A illustrates an example method 700 of setting the mode of the portable heating/purifying/fan unit 1. Setting the mode begins upon detecting a press of the power button, at 702, and then mode button 37 is displayed on the screen 27. Upon selection of the mode button 37, at 704, the screen 27, in the preferred embodiment, displays, at 706, options for selecting either “heater”, “purifier”, heater & purifier” and “fan only”. FIG. 7B illustrates an example view of these options displayed on the display 27. Upon using the up/down buttons 29, 31 and the selection of the “heater” only option, at 708, or the “purifier” mode, at 710, or the “heater & purifier” mode, at 712, or the “fan only” mode, at 714, the control processor 43 causes the display 27 to display a “high power” and “energy saving” options. Upon detecting the “high power” option was selected, at 716, or the “energy saving” option was selected, at 718, the control user is returned to the home screen and the unit 1 begins to operate in the selected mode, at 720 (unless the mode selection was selected as part of a timing/scheduling operation as discussed below). Note that in some configurations, if the “heater” or “heater & purifier” mode was selected, then the method 700 would include a step of inputting a temperature value using the up/down buttons 29, 31.

FIG. 8A illustrates an example method 800 of how to set a schedule of operation of the heater/purifier/fan unit 1. Upon a detection of the soft schedule key 39 being pressed, the unit 1 displays options for selecting either “schedule on”, “schedule off” and “set schedule” as illustrated in example FIG. 8B. The user can use the up/down buttons 29, 31 to select one of these three options and then enter it by pressing the select button 39. Upon detecting a selection of “schedule on”, at 804, a determination is made if a schedule exists, at 808. If a schedule exists, the user is returned to the home screen and the existing schedule is turned on, at 810.

If a schedule is determined not to exist, at 808, or it is determined that the user selected “set schedule”, at 805, then the user is prompted to enter a day of the week, Monday through Friday, at 812. Next, the user is prompted to enter either a “wake”, “leave”, “return”, or “sleep” time, at 814. This time is entered, at 816, using the up/down button 29, 31 in combination with other soft buttons. The mode of operation of the unit 1 (“heater”, “purifier”, “heater & purifier” or “fan only”) is then entered, at 818. FIG. 7A discussed above describes the details of how to enter a mode of operation. The method 800 then prompts and determines, at 820 whether the user desires to enter another time or begin entering time for a weekend day. If another time is desired then the user is again prompted to select a type of time, at 814. If a weekend day is desired then the user is prompted to enter that day, at 822, before being prompted for the type of time, at 814.

If it is determined that “schedule off” if selected, at 806, then the current schedule is turned off, at 824, and the display 27 is returned to its home screen.

FIG. 9 illustrates an example method 900 of timer programing the heater/purifier/fan unit 1 when it is off. A detection that the soft timer button 41 has been pressed is made, at 902, when the timer is off. This causes the four options: “turn on in 30 minutes”, “turn on in 60 minutes”, “custom timer” and “cancel timer” to be displayed in the display 27. If a detection is made that “turn on in 30 minutes” has been selected, at 904 or that “turn on in 60 minutes” has been selected, at 906, or that “custom timer” has been selected, at 908, the control processor 43 causes the display 27 to prompt with a series of questions (as described above with reference to FIG. 7A) to determine, at 912, a mode (“heater”, “purifier”, heater & purifier” and “fan only”) of operation of the unit 1.

A determinate is next made, at 914, to determine if the unit is to turn off at the end of this program. If so, a “timer setup complete message” will be displayed, at 916, and the unit 1 will run as programmed until the programmed time period expires and it will turn off. If the unit 1 is determined, at 914, not to go off at the end of the timer then an off time is selected, at 917. At 918, a determination is made as to whether the program should repeat every week.

If it is determined, at 910, that the “cancel timer” message was selected then the control processor 43 causes, at 920, the display 27 to return to the home screen and all timers are turned off.

FIG. 10 illustrates and example method 1000 of timer programing the heater/purifier/fan unit when it is on. A detection that the soft timer button 41 has been pressed is made, at 1002, when the timer is on. This causes the four options: “shut off in 30 minutes”, “shut off in 60 minutes”, “custom timer” and “cancel timer” to be displayed in the display 27. If a detection is made that “shut off in 30 minutes” has been selected, at 1004, then the unit 1 will shut off in 30 minutes. Next a determination is made, at 1014, if the unit 1 should come back on? If so, the control processor 43 causes the display 27 to prompt with a series of questions (as described above with reference to FIG. 7A) to determine, at 1018, a mode (“heater”, “purifier”, heater & purifier” and “fan only”) of operation of the unit 1, otherwise the flow ends. After the mode has been selected, a determination is made, at 1022, if the programed timing is to repeat every day of the week? If so, the program will repeat each day of the week and a “timer setup complete message” will be displayed, at 1024, and the unit 1 will run as programmed repeatedly each day of the week, otherwise it will run as programed for a single day.

If a detection is made that “shut off in 60 minutes” has been selected, at 1006, then the unit 1 will shut off in 60 minutes. A determination is again made, at 1014, if the unit 1 should come back on and flow follows a similar path for when “shutoff in 30 minutes” is selected as discussed above.

If a detection is made that “custom timer” has been selected, at 1008, then the off time is entered, at 1026. A determination is again made, at 1014, if the unit 1 should come back on and flow follows a similar path for when “shutoff in 30 minutes” is selected as discussed above.

If it is determined, at 1010, that the “cancel timer” message was selected then the control processor 43 causes, at 1020, the display 27 to return to the home screen and all timers are turned off.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A portable space heater comprising:
a housing;
a heating unit in the housing;
a control processor adapted to receive a wireless message from a wireless network and to decode the wireless message and to control the portable space heater based, at least in part, on the wireless message.

2. The portable space heater of claim 1 further comprising:
a light emitting diode (LED) display for displaying settings describing operating characteristics of the portable space heater and to aid in selecting operating characteristics of the portable space heater.

3. The portable space heater of claim 2 further comprising:
a control panel comprising the LED display and further comprising:
an up button; and
a down button, wherein the up button and the down button are configured allow a user to input a temperature setting that the portable space heater is to heat to.

4. The portable space heater of claim 3 wherein the control panel further comprising:
a soft button, where functionality of the soft button is controlled by the control processor to determine what the portable space heater is being program to do and wherein the control processor causes the LED display to display a current functionality of the soft button adjacent the soft button.

5. The portable space heater of claim 3 further comprising:
an air purifier adapted to filter air passing through the portable space heater.

6. The portable space heater of claim 5 further comprising:
a fan adapted to move air threw the portable space heater.

7. The portable space heater of claim 6 wherein the control panel further comprises:
at least one button, wherein the control panel and the at least one button are configured to place the portable space heater into at least one of the following operating modes: heat only mode, heat and air purification mode, purification mode and fan only mode.

8. The portable space heater of claim 1 wherein the control processor is adapted to receive the wireless message from at least one of the group of: a remote computer, a remote laptop computer, an iPad, a remote cellular phone and another electronic device.

9. The portable space heater of claim 1 further wherein the wherein the control processor is adapted to receive the wireless message in the form of a wireless packet.

10. The portable space heater of claim 1 wherein the wireless network is an Institute of Electrical and Electronics Engineers (IEEE) 802.11 network.

11. A method of operating a portable space heater comprising:
receiving a wireless message from a wireless network; and
controlling the portable space heater based, at least in part, on a message in the wireless message.

12. The method of operating a portable space heater of claim 11 further comprising:
displaying instructions associated with operating the portable space heater on a light emitting diode (LED) display.

13. The method of operating a portable space heater of claim 11 further comprising:
providing a high power option and low power option when a selection to operate the portable space heater in one of the following modes is selected: a heater mode and a heater and purifier combined mode.

14. The method of operating a portable space heater of claim 11 further comprising:
providing a way to specify the portable space heater is to operate in an operation mode that is one of the following group of operation modes: a heater only mode, a heater and purifier mode, a fan only mode and a purifier mode.

15. The method of operating a portable space heater of claim 14 further comprising:
providing a way to schedule the portable space heater to operate at different operation modes at different times of a day.

16. The method of operating a portable space heater of claim 14 further comprising:
providing a way to specify a custom start time for a particular operation mode and an end time of the particular operation mode.

17. The method of operating a portable space heater of claim 14 further comprising:
providing a way to create a schedule for the portable space heater to operate at different operation modes at different times of each day of a weak, wherein the schedule continues until changed or cancelled.

18. The method of operating a portable space heater of claim 14 wherein the providing a way to specify the portable space heater is to operate in an operation mode further comprises:
providing a way to specify the portable space heater is to operate in an operation mode on a remote device selected from the group of: a remote computer, a remote laptop computer, an iPad, a remote cellular phone and another electronic device.

19. The method of operating a portable space heater of claim 14 wherein the receiving a wireless message from a wireless network further comprises:
receiving the wireless message with an operation mode contained in the wireless message.

20. The method of operating a portable space heater of claim 11 further comprising:
providing way to select a predetermined amount of time for the portable space heater to run; and
providing a way to specify a custom amount of time for the portable space heater to run.
